(19) United States
(12) Patent Application Publication
(10) Pub. No.: US 2007/0206666 A1
(43) Pub. Date: Sep. 6, 2007

(54) Digital satellite receiver and method for expanding digital satellite radio coverage for devices

(76) Inventor: Frank M. Hirschenberger, Oxford, MI (US)

Correspondence Address: DELPHI TECHNOLOGIES, INC., M/C 480-410-202, PO BOX 5052, TROY, MI, 48007, US

(21) Appl. No.: 11/365,422

(22) Filed: Mar. 1, 2006

(51) Int. Cl. H04B 3/36

(52) U.S. Cl. 375/211

(57) ABSTRACT

A system for receiving and processing a digital satellite radio signal includes an antenna for receiving a digital satellite radio signal, and a repeater module for receiving digital satellite radio signals is a first frequency band from the antenna, converting those signals into converted satellite signals in a second frequency band, and transmitting the converted satellite signals. The system also includes at least one receiver module for receiving the converted satellite signals transmitted by the repeater module and extracting data directly from the received converted satellite signals.

### TECHNICAL FIELD

The present invention is generally directed to RF receivers, and, more specifically, to a digital satellite RF receiver and method of improving digital satellite RF receiver access to digital satellite signals.

### BACKGROUND OF THE INVENTION

Satellite digital audio radio (SDAR) services have become increasingly popular, offering digital radio services covering large geographic areas, such as North America. These services receive uplinked programming which, in turn, is rebroadcast directly to digital radios that subscribe to the service. Each subscriber to the service generally possesses a digital radio having a receiver and one or more antennas for receiving the digital broadcast.

Although many digital radios have been designed for use in vehicles, other digital radios are increasingly being designed for use in the home or office environment, and for personal portable or wearable usage, including in outdoor environments.

In satellite digital audio radio services systems, the digital satellite receivers are generally programmed to receive and decode the digital satellite signals, which typically include many channels of digital audio. These signals are received directly from satellites, or from terrestrial repeaters that retransmit the digital satellite signals in order to provide improved coverage and availability. In addition to broadcasting encoded digital quality audio signals, the satellite service may also transmit data that may be used for various other applications. The broadcast signals may include advertising, information about warranty issues, information about the broadcast audio programs, and news, sports, and entertainment programming. Thus, the digital broadcasts may be employed for any of a number of satellite audio radio, satellite television, satellite Internet, and various other consumer services.

In order for a subscriber to receive digital satellite content via a digital radio, the receiver section of the digital radio typically must be able to receive the digital satellite signal from a satellite or repeater. In most geographic areas, a clear uninterrupted view of the sky is generally required in order to properly receive the satellite signal. This can be problematic in situations in which a user wishes to use a digital satellite receiver while located inside a structure, such as a vehicle, or when the user is unable to locate the receiver such that the receiver can receive a digital satellite signal from a satellite or terrestrial repeater.

For example, vehicles equipped for providing satellite-based services generally include one or more antennas for receiving the satellite digital broadcast. One example of an antenna arrangement includes one or more antennas mounted in the sideview mirror housing(s) of an automobile. The antennas(s) may be mounted at other locations, depending on factors such as vehicle type, size, and configuration. While these antennas are capable of providing a digital satellite signal to a digital satellite receiver (typically mounted in the vehicle and directly connected to the antenna), they are not typically able to provide that signal to portable digital receivers carried by users in the vehicle compartment. Due to the enclosed nature of the vehicle compartment, it may be difficult for users of portable digital receivers to obtain an adequate digital satellite signal without being directly tethered to the vehicle antenna.

Another example of a situation in which digital satellite signals may be inadequate for portable digital receiver use is in the home or office environment. Typically, a home-user of digital satellite radio will have an antenna attached to the roof of the home, or in another location (such as near a window) where an adequate digital satellite signal can be received. While this can work well for satellite receivers directly connected to the antenna, portable digital satellite receiver users who wish to use their devices without being “tethered” to the fixed antenna might find it difficult to receive an adequate digital satellite signal without moving to a location where the portable digital receiver can directly receive a digital satellite signal (such as outside the house or near a door or window).

One possible solution to this problem is the Delphi XM® Signal Repeater, marketed by Delphi, which receives S-band satellite signals from an antenna in the home, converts the S-band signals to a frequency in the Industrial, Scientific, and Medical (ISM) frequency band, and wirelessly retransmits the converted digital satellite signals in the ISM-band to an up-converter antenna module connected to the antenna input of a digital satellite receiver located in the house. The up-converter antenna module converts the ISM-band satellite signals back to S-band satellite signals, and provides the S-band satellite signals to the digital satellite receiver via the receiver's antenna input. At this point, the digital satellite receiver processes the S-band satellite signals as it would any standard S-band satellite signal received directly from a satellite or terrestrial repeater. By using this system, a user can effectively extend the reach of an antenna located in the house to other digital receivers in the house.

The solution discussed above provides enhanced service, but requires both down-converter circuitry to convert an S-band signal to a frequency in the ISM-band, and an up-converter antenna module to convert the ISM-band signal back to the S-band before the signal can be received and processed by a typical digital satellite receiver. The additional up-converter antenna module adds expense to portable digital satellite receiver systems, and increases the power consumption budget of those systems, which usually is not preferred in portable devices in general. In addition, this solution is designed to repeat signals transmitted by one of two popular commercially available digital satellite systems (XM®), but not both systems.

What is needed is a digital satellite receiver system that can receive retransmitted digital satellite signals that have been converted to frequency bands other than the S-band, and that can directly process digital satellite signals in frequency bands other than the S-band without requiring an S-band antenna, or circuitry to first convert a non-S-band signal to the S-band.

It would also be desirable if the digital satellite receiver system were able to effectively repeat and convert signals provided by multiple commercial satellite radio systems, such as SIRIUS™ and XM® systems.

### SUMMARY OF THE INVENTION

In accordance with one aspect of the present invention, a system for receiving and processing a digital satellite radio signal is provided. The system includes an antenna for receiving a broadcast wireless digital satellite radio signal, and a repeater module for receiving digital satellite radio signals from the antenna, converting those signals into converted satellite signals in the Industrial, Scientific, and Medical frequency range, and transmitting the converted satellite signals. The system also includes at least one receiver module for receiving the converted satellite signals transmitted by the repeater module and extracting data directly from the received converted satellite signals.

In accordance with another aspect of the present invention, a digital satellite radio receiver for receiving satellite broadcast signals and satellite signals converted to the ISM frequency band by a repeater is provided.

The receiver includes at least one antenna for receiving at least one of a digital satellite radio signal and a signal in the ISM frequency band. The receiver also includes ISM receiving circuitry for receiving converted signals in the ISM frequency band and extracting data directly from the converted signals. The receiver further includes satellite receiving circuitry for receiving digital satellite radio signals and extracting data directly from the digital satellite radio signals.

In accordance with yet another aspect of the present invention, a method for processing digital satellite radio signals is provided. The method includes the steps of receiving a digital satellite radio signal in a repeater, converting the digital satellite radio signal to a converted satellite signal in the ISM frequency band to form a converted satellite ISM signal, and transmitting the converted satellite ISM signal. The method also includes the steps of receiving the converted satellite ISM signal and at least one receiver, and processing the converted satellite ISM signal in the receiver to obtain data.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a schematic diagram of a vehicle equipped with a system for receiving and processing digital satellite radio signals, according to one embodiment of the present invention;

FIG. 2 is a block diagram of the system, further illustrating the receiver elements for receiving and processing digital satellite radio signals, according to one embodiment of the present invention;

FIG. 3 is a block diagram illustrating digital satellite radio receiving and decoding circuitry in a receiver, according to another embodiment;

FIG. 4 is a block diagram illustrating digital satellite radio receiving and decoding circuitry in a receiver, according to yet another embodiment;

FIG. 5 is a block diagram illustrating front-end and receiver circuitry in a receiver for a digital satellite radio system, according to still another embodiment;

FIG. 6 is a block diagram illustrating a system for receiving and processing digital satellite radio signals using multiple repeaters, according to still another embodiment; and

FIG. 7 is a flow diagram illustrating a method for receiving and processing digital satellite radio signals, according to one embodiment.

### DESCRIPTION OF THE PREFERRED EMBODIMENTS

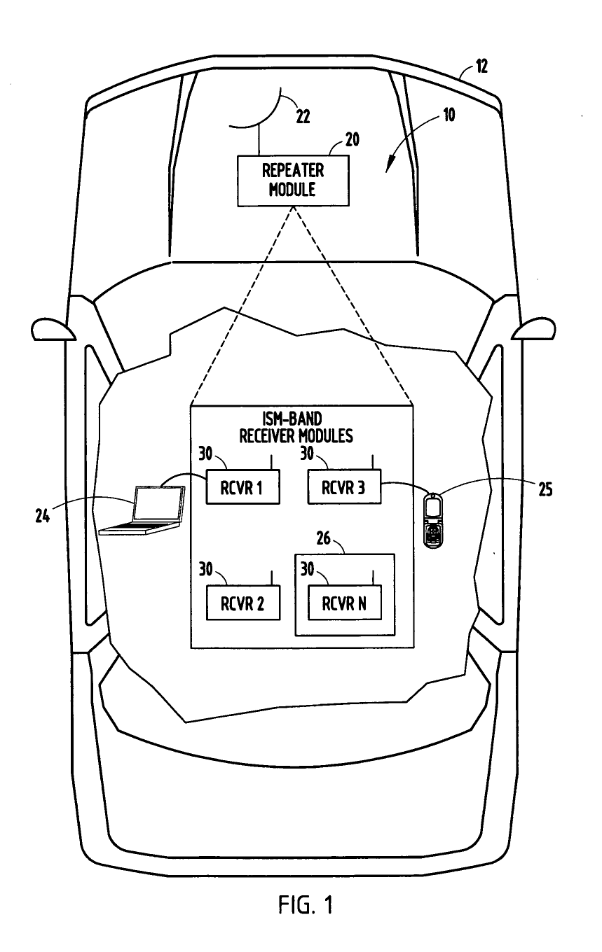

Referring to FIG. 1, a system 10 for receiving and processing digital satellite radio signals is generally illustrated located onboard a vehicle 12, such as an automobile, according to one embodiment of the present invention. The system 10 generally includes a repeater module 20 and one or more ISM-band receiver modules 30. The repeater module 20 receives broadcast satellite signals and makes the satellite broadcast data available to the receiver modules 30. While the system 10 is shown and described herein for use in a vehicle 12, it should be appreciated that system 10 may be employed in other environments.

The vehicle 12 is shown equipped with a repeater module 20 coupled to a satellite antenna 22. Repeater module 20 is configured to receive digital satellite radio signals via satellite antenna 22. The digital satellite radio signals are currently generally broadcast by remote satellites at frequencies in the 2320-2345 MHz band. Repeater module 20 also converts the digital satellite radio signals into digital radio signals in the Industrial, Scientific, and Medical frequency band (hereinafter converted satellite ISM signals), and retransmits the converted satellite ISM signals to receivers within range that are capable of receiving and processing signals in the ISM-band. The ISM-band currently generally includes the frequency ranges of 6.765-6.795; 13.553-13.567; 26.957-27.283; 40.664-40.70; 433.05-434.79; 902-928; 2,400-2,500, 5,725-5,875, 24,000-24,250; 61,000-61,500; 122,000-123,000; and 244,000-246,000 MHz.

The vehicle 12 is also shown equipped with a plurality, such as four, ISM-band receiver modules 30 located within the vehicle compartment of vehicle 12. ISM-band receiver modules 30 are configured to receive converted satellite ISM signals from repeater module 20, and to decode the converted satellite ISM signals to extract audio or other data directly from the converted satellite ISM signals. As shown, ISM-band receiver modules 30 can be connected to portable electronic devices, such as a laptop computer 24 or a cellular phone 25. ISM-band receiver modules 30 may also be directly integrated within other electronic devices, such as PDA 26. Finally, ISM-band receiver modules 30 can act as stand-alone audio receivers providing an audio output decoded from the converted satellite ISM signals.

In operation, satellite antenna 22 receives digital satellite radio signals from one or more satellite or terrestrial repeaters. The received digital satellite radio signals may be XM® satellite radio signals, SIRIUS™ digital satellite radio signals, or other broadcast digital satellite radio signals. The received digital satellite radio signals are received in a frequency band suitable for the reception and transmission of digital satellite radio signals, such as, for example, 2.320 GHz TO 2.345 GHz.

Satellite antenna 22 provides the received digital satellite radio signals to repeater module 20. Repeater module 20 converts the received digital satellite radio signals that have been received in a satellite frequency band into digital satellite radio signals in the Industrial, Scientific, and Medical frequency band. The digital satellite radio signals that have been converted into digital satellite radio signals in the ISM frequency band (converted satellite ISM signals) are then retransmitted in the ISM frequency band by repeater module 20.

The converted satellite ISM signals retransmitted by repeater module 20 are received by ISM-band receiver modules within range of repeater module 20, such as ISM-band receiver modules 30 shown located in the vehicle compartment of vehicle 12. ISM-band receiver modules 30 receive the converted satellite ISM signals in the ISM-band, and extract audio or other data directly from converted satellite ISM signals. When configured as a stand-alone receiver, an ISM-band receiver module 30 provides an audio output signal that has been decoded from a received converted satellite ISM signal. When connected to or integrated within portable electronic devices, an ISM-band receiver module 30 provides audio or data output for use in the portable electronic device, such as for playback through speakers of a laptop computer 24, playback through the speaker of a cellular phone 25, or playback on a PDA 26.

It should be appreciated that multiple repeater modules 20 and one or more ISM-band receiver modules 30 may be located within a vehicle 12. Although repeater module 20 and ISM-band receiver modules 30 are shown in a vehicle 12, it should also be appreciated that repeater module 20 and ISM-band receiver modules 30 could be located in other structures, such as houses or other buildings, or could be located in an outside environment. It should also be appreciated that more than one antenna 22 could be connected to repeater module 20, and that ISM-band receiver modules 30 could have one or more antennas for receiving ISM-band signals, satellite band signals, or signals in another frequency band.

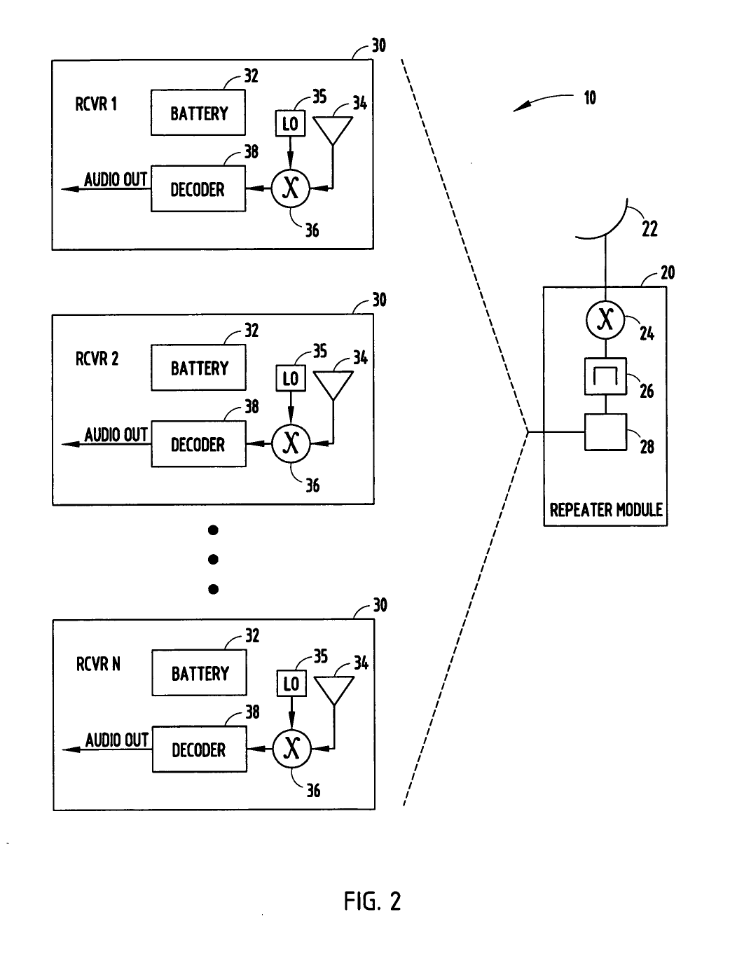

Referring to FIG. 2, the system 10 for receiving and processing digital satellite radio signals is generally illustrated, according to a first embodiment. The system 10 includes a satellite antenna 22 for receiving digital satellite radio signals broadcast in a satellite frequency band. The system also includes the repeater module 20 coupled to the satellite antenna 22 for receiving digital satellite radio signals, converting the received digital satellite radio signals to signals in the ISM frequency band (converted satellite ISM signals), and retransmitting or broadcasting the converted digital satellite radio signals to remote receivers 30 capable of receiving digital satellite radio signals broadcast in the ISM frequency band. The repeater module 20 includes mixer circuitry for converting received digital satellite signals to signals into an ISM frequency band, filter circuitry 26 for filtering the converted signals to exclude non-ISM-band signals, and gain control circuitry 28 for limiting the power of signals transmitted by repeater module 20 to power levels meeting FCC requirements. The broadcast transmission of the converted digital satellite radio signals is at a power level sufficient to cover the range of the intended application, e.g., to cover the entire vehicle passenger compartment.

As shown, the system 10 includes multiple ISM-band receivers 30 for receiving converted satellite ISM signals from repeater module 20. Receiver modules 30 are shown each having a battery 32 for providing power to the circuitry of receiver module 30. In addition, or alternatively, a non-battery power supply may be employed to supply the power. Each receiver module 30 is also shown having an ISM-band antenna 34 for receiving converted satellite ISM signals in an ISM frequency band. ISM-band antenna 34 provides received converted satellite ISM signals to a mixer 36. Mixer 36 is also shown receiving a signal from a local oscillator 35. Local oscillator 35 is configured to provide a signal (such as a sine wave) to mixer 36 to enable mixer 36 to convert the received converted satellite ISM signal to a base-band signal at about 0 Hz. Mixer 36 is also configured to provide the resulting base-band (0 Hz) signal to decoder 38. Decoder 38 is configured to extract audio signals from converted satellite ISM base-band signals provided by mixer 36, and to provide an audio output from the receiver module 30.

In operation, satellite antenna 22 receives a digital satellite radio signal from a satellite or terrestrial repeater. The received digital satellite radio signal may include audio and/or other data. Satellite antenna 22 provides the received digital satellite radio signal to repeater module 20. Repeater module 20 converts the received digital satellite radio signal into a converted satellite ISM signal in an ISM frequency band. Repeater module 20 then filters the converted satellite ISM signal to exclude frequencies outside of an ISM-band, and retransmits the converted satellite ISM signal in a more local broadcast such that receiver modules 30 within range of repeater module 20 can receive the converted satellite ISM signal. Receiver modules 30 within range of repeater module 20 receive the converted satellite ISM signal transmitted by repeater module 20 via antenna 34. In receiver modules 30, a sine wave provided by local oscillator 35 drives mixer 36 to convert the received converted satellite ISM signal to a base-band signal at 0 Hz. Decoder 38 then processes the base-band signal (0 Hz) received from mixer 36 to extract audio and/or other data from the base-band signal. Receiver modules 30 may be further configured to amplify the audio output signal and broadcast the audio output signal on speakers coupled to or integrated within receiver modules 30.

It should be appreciated that any number N of receiver modules 30 could receive and process converted satellite ISM signals to provide audio output for each receiver module 30. It should also be appreciated that the system 10 illustrated in FIG. 2 could be implemented in a vehicle, in a structure, such as a building or a house, or outside. As shown, satellite antenna 22 and repeater module 20 are capable of receiving, converting, and rebroadcasting in an ISM frequency band digital satellite radio signals transmitted by the XM® system, the SIRIUS™ system, both systems, or any other digital satellite radio system. In addition, receiver modules 30 may be further capable of receiving and processing in an ISM frequency band digital satellite radio signals from the XM® system, the SIRIUS™ system, both systems, or any other digital satellite radio system.

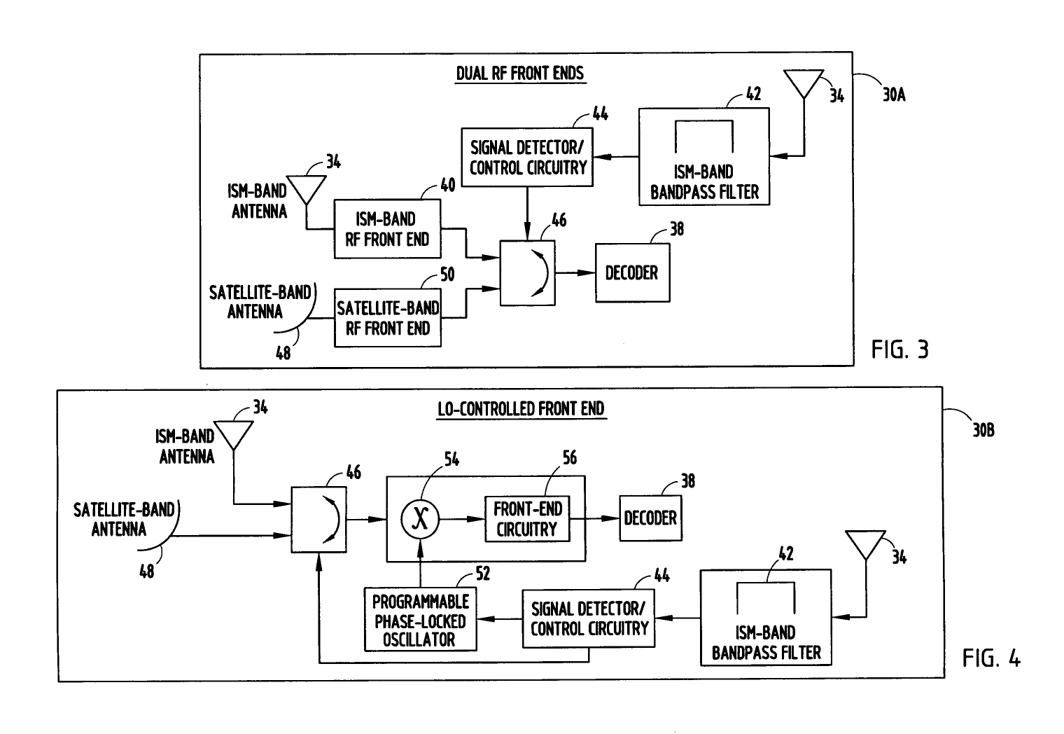

Referring to FIG. 3, a digital satellite radio receiver 30A for receiving digital satellite radio signals and converted satellite ISM signals in the system 10 is generally illustrated, according to a second embodiment. Digital satellite radio receiver 30A is shown having a first ISM-band antenna 34 connected to an ISM-band bandpass filter 42 for receiving signals in an ISM frequency band. ISM-band bandpass filter 42 provides a signal to signal detector/control circuitry 44, which provides a signal to switch 46 indicative of the strength or quality of the received signal in an ISM frequency band. Digital satellite radio receiver 30A is also shown having a second ISM-band antenna 34 coupled to an ISM-band RF front-end circuit 40 for receiving signals transmitted in an ISM frequency band. ISM-band RF front-end circuit 40 is configured to receive a digital satellite radio signal that has been converted into an ISM frequency band, convert the ISM-band input signal to a base-band (0 Hz) signal, and pass the base-band signal to switch 46. Digital satellite radio receiver 30A is also shown having a satellite band antenna 48 for receiving digital satellite radio signals transmitted in a satellite frequency band such as the S-band. Satellite band antenna 48 is shown coupled to a satellite band RF front-end circuit 50. Satellite band RF front-end circuit 50 receives digital satellite radio signals broadcast in a satellite band, converts the satellite-band signals to base-band (0 Hz) signals, and provides the base-band signals to switch 46. Switch 46 is shown providing the base-band signal from the ISM-band RF front-end circuit 40 or the satellite-band RF front-end circuit 50 to a decoder 38. Switch 46 determines which of the base-band signals to provide to decoder 38 based on the signal strength/quality signal provided by signal detector/control circuitry 44. Decoder 38 is configured to decode the base-band signal to provide audio or other output data.

In operation, ISM-band bandpass filter 42 receives a digital satellite radio signal that has been converted to an ISM frequency band (converted satellite ISM signal) via antenna 34. After filtering the received signal to exclude non-ISM frequencies, ISM-band bandpass filter 42 provides a filtered signal to signal detector/control circuitry 44. Signal detector/control circuitry 44 provides a signal to switch 46 indicative of the strength or quality of the received converted satellite ISM signal. Based on the information provided by signal detector/control circuitry 44, switch 46 determines whether a base-band signal from ISM-band RF front-end circuit 40 or a base-band signal from satellite band RF front-end circuit 50 will be provided to decoder 38. If signal detector/control circuitry 44 indicates that a converted satellite ISM signal is either too weak or unavailable, switch 46 will select satellite band RF front-end circuit 50 as the source for the base-band signal to be processed by decoder 38. If, however, signal detector/control circuitry 44 determines that an adequate converted satellite ISM signal is available, switch 46 will select ISM-band RF front-end circuit 40 as the source for the base-band signal to be processed by decoder 38.

To create base-band signals in ISM-band RF front-end circuit 40, converted satellite ISM signals are first received in ISM-band antenna 34 and provided by ISM-band antenna 34 to ISM-band RF front-end circuit 40. ISM-band RF front-end circuit 40 then processes the received ISM-band signals to convert them to base-band signals, and provides the resulting base-band signals to switch 46. To create base-band signals in satellite-band RF front-end circuit 50, satellite band antenna 48 first receives digital satellite radio signals in the satellite band, and provides those signals to satellite band RF front-end circuit 50. Satellite band RF front-end circuit 50 then processes the digital satellite radio signals received in the satellite frequency band to convert them to base-band signals, and passes the resulting base-band signals on to switch 46. As noted above, switch 46 determines which base-band signals will be passed on to decoder 38 for further processing. Decoder 38 then processes the selected base-band signals to extract audio or other information.

Although the receiver 30A in FIG. 3 shows two ISM-band antennas 34, it should be appreciated that one ISM-band antenna 34 could provide input signals both to ISM-band bandpass filter 42 and ISM-band RF front-end circuit 40. In addition, it should be appreciated that more than two ISM-band antennas 34 could be utilized in the receiver, and that more than one satellite band antenna 48 could be utilized in the receiver 60. It should also be appreciated that although one ISM-band RF front-end circuit and one satellite band RF front-end circuit are shown in FIG. 3, receiver 30A could have multiple ISM-band RF front-end circuits and multiple satellite band RF front-end circuits with switch 46 operating to select an optimal base-band signal for further processing in decoder 38.

Referring to FIG. 4, a digital satellite radio receiver 30B for receiving digital satellite radio signals and converted satellite ISM signals in system 10 is generally illustrated according to a third embodiment. Receiver 30B is shown having a first ISM-band antenna 34 for providing a digital satellite radio signal that has been converted into an ISM frequency band to a switch 46. Receiver 30B is also shown having a satellite band antenna 48 for providing a digital satellite radio signal in the satellite frequency band to switch 46. Receiver 30B is also shown having a second ISM-band antenna 34 for receiving a digital satellite radio signal that has been converted to an ISM frequency band, and providing that signal to ISM-band bandpass filter 42 for filtering frequencies outside the ISM-band. ISM-band bandpass filter 42 is configured to provide a filtered converted satellite ISM signal to signal detector/control circuitry 44. Signal detector/control circuitry 44 is configured to evaluate the strength and/or quality of the ISM signal provided by filter 42, and provide a signal quality output signal to switch 46 and programmable oscillator 52. Programmable oscillator 52 is configured to provide a signal (such as a sine wave) to mixer 54 to drive mixer 54 and front-end circuitry 56 to convert an input signal from switch 46 to a base-band (0 Hz) signal. Front-end circuitry 56 is configured to provide the resulting base-band signal to decoder 38. Decoder 38 is configured to process the base-band signal to extract audio or other information.

In operation, second ISM-band antenna 34, ISM-band bandpass filter 42, signal detector/control circuitry 44, and switch 46 operate in a manner similar to that discussed for the embodiment shown in FIG. 3. In summary, signal detector/control circuitry 44 determines whether a converted satellite ISM signal of sufficient strength is available for processing. If signal detector/control circuitry 44 determines that a converted satellite ISM signal is either unavailable or too weak, signal detector/control circuitry 44 provides a signal to switch 46 such that switch 46 will select the satellite band antenna 48 as the source for a signal to be further processed. If signal detector/control circuitry 44 determines that an adequate converted satellite ISM signal is available, signal detector/control circuitry 44 provides a signal to switch 46 such that switch 46 selects the ISM-band antenna 34 as the source for the signal to be further processed.

Signal detector/control circuitry 44 also provides a signal indicative of the availability of an adequate ISM-band signal to programmable phase-locked oscillator 52. Programmable phase-locked oscillator 52 utilizes the signal from signal detector/control circuitry 44 to select the frequency at which to drive mixer 54. If signal detector/control circuitry 44 indicates that an adequate ISM signal is available, oscillator 52 provides a frequency that will enable mixer 54 and front-end circuitry 56 to convert an ISM-band signal received from switch 46 to base-band. If an adequate ISM signal is not available, oscillator 52 provides a frequency that will enable mixer 54 and front-end circuitry 56 to convert a satellite-band signal from switch 46 to base-band. In this manner, one set of circuitry can be actively reconfigured based on signals from signal detector/control circuitry 44 to process signals in either an ISM-band or a satellite band. Once mixer 54 and front-end circuitry 56 have processed the ISM-band signal or satellite band signal, front-end circuitry 56 provides the resulting processed base-band digital satellite radio signal to decoder 38 for extraction of audio and/or other data.

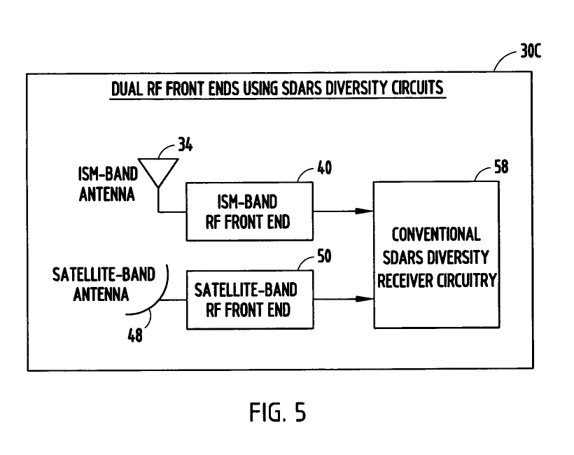

Referring to FIG. 5, a digital satellite radio receiver 30C for receiving digital satellite radio signals and converted satellite ISM signals in system 10 is generally illustrated, according to a fourth embodiment. Digital satellite radio receiver 30C is shown having an ISM-band antenna 34 for receiving digital satellite radio signals broadcast in an ISM frequency band. ISM-band antenna 34 provides the received ISM-band signal to ISM-band RF front-end circuit 40. ISM-band RF front-end circuit 40 is configured to process the received converted satellite ISM signal to convert the received signal to a base-band signal. ISM-band RF front-end 40 is also configured to provide the base-band digital satellite radio signal extracted from the converted satellite ISM signals to receiver circuitry 58, which may include conventional SDARS diversity receiver circuitry.

Receiver 30C is also shown having a satellite band antenna 48 for receiving digital satellite radio signals broadcast in a satellite frequency band. Satellite band antenna 48 provides a received digital satellite radio signal to satellite band RF front-end circuit 50. Satellite band RF front-end 50 is configured to process the digital satellite radio signals received in the satellite frequency band to convert the received digital satellite radio signals to base-band signals, and provide the resulting base-band signals to receiver circuitry 58, which may include conventional SDARS diversity receiver circuitry. Receiver circuitry 58 is configured to evaluate the base-band digital satellite radio signals received from ISM-band RF front-end 40 and satellite band RF front-end 50 to determine which signal source to use, and to further process that signal source to extract audio and/or other data.

In operation, ISM-band antenna 34 receives a converted satellite ISM signal and provides that signal to ISM-band RF front-end circuit 40. ISM-band RF front-end circuit 40 processes the received converted ISM signal to convert it to a base-band signal. ISM-band RF front-end circuit 40 then provides the resulting base-band signal to diversity receiver circuitry 58. In a similar manner, satellite-band antenna 48 receives a digital satellite radio signal and provides that signal to satellite-band RF front-end circuit 50. Satellite-band RF front-end 50 processes the received digital satellite radio signal to convert it to a base-band signal. Satellite-based RF front-end 50 then provides the resulting base-band signal to diversity receiver circuitry 58. Diversity receiver circuitry 58 evaluates the received base-band signals, and processes one or more of the base-band signals to extract and/or process audio and/or other data.

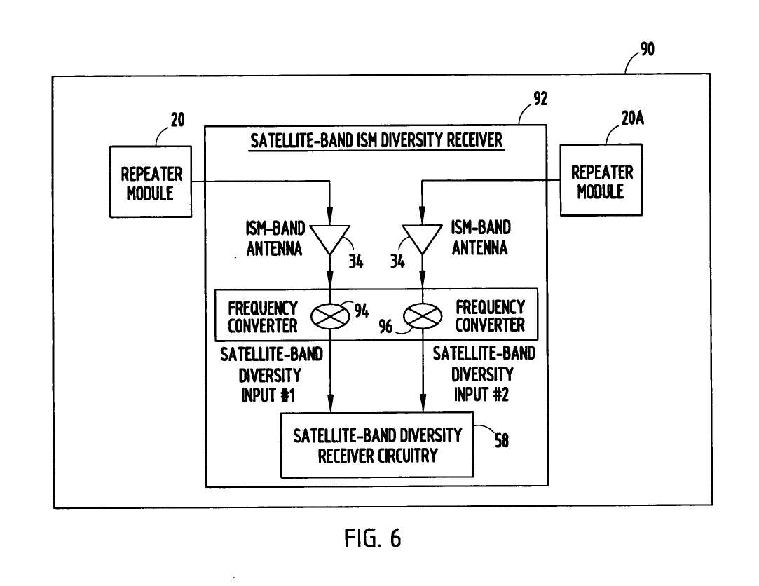

Referring to FIG. 6, a system 90 for receiving and processing digital satellite radio signals is generally illustrated, according to yet another embodiment of the present invention. System 90 includes a first repeater module 20 located at a first location, such as in a vehicle. Repeater module 20 is configured to receive digital satellite radio signals in the satellite frequency band, and rebroadcast the digital satellite signals in a first frequency band within the ISM frequency band. System 90 also includes a second repeater module 20A located at a second location, such as in the vehicle. Repeater module 20A is configured to receive digital satellite radio signals in the satellite frequency band, and rebroadcast the digital satellite radio signals at a second frequency in the ISM frequency band.

System 90 is also shown having satellite band ISM diversity receiver 92. Satellite band ISM diversity receiver 92 includes a first ISM antenna 34 configured to receive a converted satellite ISM signal from repeater module 20 and provide the converted satellite ISM signal to a first frequency converter 94. First frequency converter 94 is configured to receive a converted satellite ISM signal transmitted by repeater module 20 at a first frequency in the ISM-band, and convert the digital satellite radio signal from the received converted satellite ISM signal in the first frequency band to a base-band signal. Receiver 92 is also shown having a second ISM-band antenna 34 configured to receive a converted satellite ISM signal transmitted by repeater module 20A and provide that received signal to a second frequency converter 96. Second frequency converter 96 is configured to receive a converted satellite ISM signal transmitted by repeater module 20A at a second frequency in the ISM-band that is different from the first frequency transmitted by repeater module 20, and to convert the digital satellite radio signal from the received converted satellite ISM signals in the second frequency band to a base-band signal. Both first frequency converter 94 and second frequency converter 96 are shown providing base-band digital satellite radio signals extracted from ISM-band signals to satellite band diversity receiver circuitry 58. Satellite band diversity receiver circuitry 58 may include conventional circuitry that is configured to select from among the different base-band digital satellite radio signals provided by first frequency converter 94 and second frequency converter 96, and process the selected base-band signal to extract and/or process audio and/or other data.

It should be appreciated that while the system 90 of FIG. 6 shows first and second repeater modules 20 and 20A and first and second frequency converters 94 and 96, more than two repeater modules and frequency converter modules may be used in the system 90. Additional repeater modules and/or frequency converters may be used at the same first and second frequencies discussed, or may be used at additional frequencies.

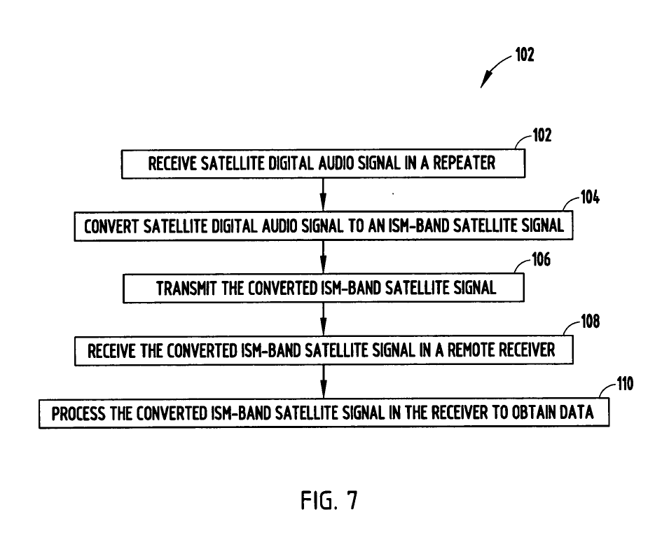

Referring to FIG. 7, a method 100 for receiving and processing digital satellite radio signals with system 10 or 90 is provided, according to one embodiment of the present invention. In a first step 102, a satellite digital audio signal is received in a repeater module. Next, in step 104, the satellite digital audio signal is converted to a signal in the ISM-band. In a third step 106, the converted satellite signal in the ISM-band is transmitted. Next, in step 108, a converted ISM-band satellite signal is received in a remote receiver. Next, in step 110, the converted ISM-band satellite signal is processed in the receiver to obtain data.

It should be appreciated that satellite and ISM frequency bands could be changed in the future, and that references to satellite and ISM frequency bands are intended to comprehend additional frequencies that might be added to bands currently supporting satellite and ISM wireless communication.

As described, the present invention provides the benefit of a digital satellite receiver system that is capable of directly processing converted digital satellite signals without the need for additional antennas or circuitry to re-convert the digital satellite signals into a satellite frequency range. In addition, the present invention provides for a digital satellite receiver system that is capable of retransmitting and processing signals provided by more than one conventional satellite radio system.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A system for receiving and processing digital satellite radio signals, comprising:
an antenna configured to receive digital satellite radio signals;
a repeater module coupled to said antenna and having signal processing circuitry and signal transmission circuitry, said repeater module being configured to receive digital satellite radio signals in a first frequency range from said antenna, process the digital satellite radio signals to convert the digital satellite radio signals into converted satellite signals in a second frequency range, and to further transmit the converted satellite signals; and
at least one receiver module configured to receive and process the converted satellite signals in the second frequency range transmitted by said repeater module, wherein said at least one receiver module processes the received converted satellite signals in the second frequency range to extract data directly from the received converted satellite signals.

2. The system of claim 1, wherein the digital satellite radio signals received and processed by said repeater module are S-band digital satellite radio signals.

3. The system of claim 1, wherein the data extracted from the received converted satellite signals comprises audio/data.

4. The system of claim 1, wherein said repeater module and at least one of said at least one receiver modules is located in a vehicle.

5. The system of claim 1, wherein at least one of said at least one receiver modules is connected to a portable electronic device.

6. The system of claim 1, wherein at least one of said at least one receiver modules is integrated within a portable electronic device.

7. The system of claim 1, wherein said repeater module is configured to receive and process a plurality of digital satellite radio signals comprising XM® and SIRIUS™ digital satellite radio signals.

8. The system of claim 1, wherein said receiver module is further configured to receive and process digital satellite radio signals in a first frequency range.

9. The system of claim 8, wherein said at least one receiver module is configured to switch between processing converted satellite signals in a second frequency range and digital satellite radio signals in a first frequency range, and wherein said receiver module directly processes digital satellite radio signals in the first frequency range when the at least one receiver module determines that a converted satellite signal in a second frequency range is unavailable.

10. The system of claim 1, wherein the first frequency range is a frequency range used to transmit satellite signals among satellites, terrestrial satellite repeaters and satellite receivers, wherein said second frequency range is an Industrial, Scientific and Medical (ISM) frequency range, and wherein said converted satellite signals are converted satellite ISM signals.

11. A digital satellite radio receiver for receiving satellite digital radio signals in a first frequency band and converted satellite signals converted to a second frequency band by a repeater, comprising:
at least one antenna configured to receive at least one of a digital satellite radio signal in a first frequency band and a converted satellite signal in a second frequency band;
receiving circuitry configured to receive converted satellite signals in the second frequency band from a repeater module and extract data from the converted satellite signals; and
satellite receiving circuitry configured to receive digital satellite radio signals in a first frequency band and extract data from the digital satellite radio signals.

12. The digital satellite radio receiver of claim 11, wherein the data extracted from the converted satellite signals comprises at least one of audio and data.

13. The digital satellite radio receiver of claim 11, further comprising switching circuitry configured to switch between processing a digital satellite radio signal in a first frequency band and a converted satellite signal in a second frequency band received from a repeater, wherein said switching circuitry selects a converted satellite signal in the second frequency band for processing in said receiving circuitry when a converted satellite signal in a second frequency is available, and wherein said switching circuitry otherwise selects a digital satellite radio signal in the first frequency band for processing in said receiving circuitry.

14. The digital satellite radio receiver of claim 11, wherein at least one of said receiving circuitry and satellite receiving circuitry is located in a vehicle.

15. The digital satellite radio receiver of claim 11, wherein said satellite receiving circuitry is capable of receiving both SIRIUS™ and XM® signals.

16. The digital satellite radio receiver of claim 11, wherein at least one of said receiving circuitry and satellite receiving circuitry is located in a portable electronic device.

17. The digital satellite radio receiver of claim 11, wherein at least one of said receiving circuitry and satellite receiving circuitry is connected to a portable electronic device.

18. The digital satellite radio receiver of claim 11, wherein said first frequency range is a satellite frequency range, and said second frequency range is a frequency range in an ISM-band.

19. A method for processing satellite digital audio signals, comprising the steps of:
receiving a digital satellite radio signal in a first frequency band in a repeater;
converting the digital satellite radio signal to a converted satellite signal in a second frequency band in the repeater;
transmitting the converted satellite signal;
receiving the converted satellite signal in at least one remote receiver module; and
processing the converted satellite signal in the at least one remote receiver module to obtain data.

20. The method of claim 19, wherein the data obtained by processing the converted satellite signal comprises at least one of audio and data.

21. The method of claim 19, further including the step of receiving a digital satellite radio signal at a first frequency in the at least one remote receiver module.

22. The method of claim 21, further including the step of processing the digital satellite radio signal in the first frequency band in the at least one receiver module when a converted satellite signal in a second frequency band is not available.

23. The method of claim 19, wherein said first frequency band is a satellite frequency band, and wherein said second frequency band is an ISM frequency band.
